(19) United States
(12) Patent Application Publication
(10) Pub. No.: US 2022/0180508 A1
(43) Pub. Date: Jun. 9, 2022

(54) Sea lice detection device and method for detection of sea lice

(71) Applicant: Submerged AS, Rissa (NO)

(72) Inventors: Lars Martin Sandvik AAS, Lysaker (NO); Håvard Lein BRAA, Rissa (NO)

(21) Appl. No.: 17/436,490

(22) PCT Filed: Feb. 18, 2020
(86) PCT No.: PCT/NO2020/050041

§ 371 Date: Sep. 3, 2021

(30) Foreign Application Priority Data
Mar. 6, 2019 (NO) 20190310

(51) Int. Cl. G06T 7/00; A01K 61/13; A01K 61/95

(52) U.S. Cl. CPC G06T 7/0012; A01K 61/13; G06T 2207/30004; G06T 2207/10004; G06T 2207/10024; A01K 61/95

(57) ABSTRACT

The invention relates to a system and method that enables the capture of high contrast images of sea lice contaminated fish. The system comprises a light emitting device, a 2D array detector, and a first polarisation filter, and utilizes polarised narrow bands of light in order to obtain a strong contrast between sea lice and the skin of the fish. A number of narrow bands of light are irradiated onto a fish, and the resulting reflection(s) is/are polarisation filtered before being detected. The detected light is subsequently used in order to generate a high contrast image of the fish.

### TECHNICAL FIELD

The disclosure relates to an underwater polarimetric reflectance imaging system for imaging sea lice contaminated fish, the use of such a system, a fish imaging method for obtaining an image with a high contrast between fish and sea lice, and a method for detecting sea lice on fish.

### BACKGROUND

Aquaculture is a growing international industry. Farming of species in the Salmonidae fish family is, due to high commercial demand, an important growing industry for countries at the Atlantic and Pacific coasts. The cost efficiency of the farming needs, however, to increase in order to feed more people with high quality and sustainable farmed fish.

Due to high fish concentrations, fishes in pens have a high risk of getting contaminated by diseases or parasites. Regulations have therefore been applied to the industry in order to limit the total biomass density and the level of contaminated fish. The authorities require inter alia classification of sea lice found on contaminated fish within the categories; adult female, mobile and stationary lice.

In order to monitor fish in fish farms, the fish farmers have to disturb the fish on a regular basis by taking a limited number of fish (typical 10-20) out of the pen to measure their weight, level of parasites and whether they have visible signs of diseases. This is a manual task performed by the tender, and disturbs the fish in its daily life by exposing the fish to both chemicals, as well as air. It is believed that these individuals have a higher mortality than their peers subsequent the examinations. The validity of the statistics can also be questioned when sampling a population of 100 000 to 200 000 by 10-20 individuals only. Sea lice host population follows as an example a negative binomial distribution, i.e. the concentration of lice is very high on a few individuals and low on others.

Autonomous sensor systems have the potential of efficiently measuring the level of parasite contamination and indication of diseases on the fish inside the pen without disturbing the fish. As these systems have the potential to measure thousands of fishes every day, they can achieve superior statistics and overall precision compared to existing methods. Implementation of autonomous systems will additionally ease the work of the fish tenders, allowing them to focus on the feeding and increasing the fish welfare for a more sustainable industry.

There are today no commercially available and proven systems for sea lice detection. The main object of the present invention is therefor to provide a system and method for efficient imaging of specimens (such as sea louse) on the surface of the fish.

### SUMMARY OF THE INVENTION

In a first aspect of the present invention, the invention provides an underwater polarimetric reflectance imaging system for imaging sea lice contaminated fish, the system comprising a light emitting device, configured to emit an L number of narrow bands of light, where each narrow band of light has a FWHM<70 nm and an average wavelength in the range 350 nm-750 nm, and where a nonzero P number of the L number of narrow bands of light is/are polarised, a 2D array detector comprising a plurality of pixel sensors, where the 2D array detector is arranged in order to detect light originating from the light emitting device, and a first polarisation filter, positioned in front of the 2D array detector.

According to an embodiment of the invention L>1 and P≥1.

At least one of the nonzero P number of polarised narrow bands of light has according to another embodiment of the invention an average wavelength within 30 nm of 405 nm or 730 nm.

According to yet another embodiment of the invention the light emitting device, the 2D array detector and the first polarisation filter are arranged in the same plane, where at least one of the nonzero P number of polarised narrow bands of light emitted by the light emitting device is linearly polarised with a polarisation direction lying in the plane, and where the first polarisation filter is a linear polariser arranged such that it blocks light with a polarisation direction essentially in the plane, or a polarisation direction essentially perpendicular to the plane.

The light emitting device comprises according to yet another embodiment of the invention a light emitting diode (LED) and a second polarisation filter arranged in front of the LED, and/or a laser.

According to yet another embodiment of the invention light emitting device, the 2D array detector and the first polarisation filter are arranged in the same watertight housing. The light emitting device is alternatively arranged in a first watertight housing, while the 2D array detector and the first polarisation filter are arranged in a second watertight housing separate from the first watertight housing.

The light emitting device is according to yet another embodiment of the invention configured to emit a narrow band of light with a FWHM<30 nm.

The underwater polarimetric reflectance imaging system comprises according to yet another embodiment of the invention a colour filter array arranged in front of the 2D array detector so that each pixel of the colour filter array covers a pixel sensor of the 2D array detector.

The underwater polarimetric reflectance imaging system comprises according to yet another embodiment of the invention a second light emitting device, configured to emit an L number of narrow bands of light, where each narrow band of light has a FWHM<70 nm and an average wavelength in the range 350 nm-750 nm, and where a nonzero P number of the L number of narrow bands of light is/are polarised.

The underwater polarimetric reflectance imaging system comprises according to yet another embodiment of the invention a computer connected with the 2D array detector, where the computer is configured to generate an image, based on a signal detected by the 2D array detector.

A second aspect of the invention concerns use of the underwater polarimetric reflectance imaging system for imaging sea lice contaminated fish.

In a third aspect of the present invention, the invention provides a fish imaging method for obtaining an image with a high contrast between fish and sea lice, the method comprising the steps of irradiating an L number of narrow bands of light onto a fish, where each narrow band of light has a FWHM<70 nm and an average wavelength in the range 350 nm-750 nm, and where a nonzero P number of the L number of narrow bands of light is/are polarised, performing polarisation filtering of a reflection of each of the L number of narrow bands of light irradiated onto the fish, detecting the polarisation filtered reflection of each of the L number of narrow bands of light irradiated onto the fish, and generating an image of the fish from the detected filtered reflection(s) of the nonzero P number of polarised narrow bands of light irradiated onto the fish.

In one embodiment of the invention L=P=1.

The image is according to another embodiment of the invention generated from the detected filtered reflection(s) of the nonzero P number of polarised narrow bands of light irradiated onto the fish, and from the detected filtered reflection(s) of the L−P number of non-polarised narrow bands of light irradiated onto the fish.

In a fourth aspect of the present invention, the invention provides a method for detecting sea lice on fish, the method comprising the steps of obtaining one or more images of a fish by employing the method according to the third aspect of the invention, identifying a sea lice in the image by evaluating the variation in the intensity in at least one image, or by evaluating the variation in the relative intensity between at least two images.

Other advantageous features will be apparent from the accompanying claims.

### BRIEF DESCRIPTION OF THE DRAWINGS

In order to make the invention more readily understandable, the discussion that follows will refer to the accompanying drawings, in which:

FIG. 1 is a schematic representation of an underwater polarimetric reflectance imaging system comprising a light emitting device, a 2D array detector and a first polarisation filter,

FIG. 2 is a schematic representation of an underwater polarimetric reflectance imaging system comprising a light emitting device, where the light emitting device emit more than one narrow band of light,

FIG. 3 is a schematic representation of an underwater polarimetric reflectance imaging system comprising two light emitting devices,

FIG. 4a is a schematic representation of a light emitting device comprising a laser,

FIG. 4b is a schematic representation of a light emitting device comprising a plurality of lasers,

FIG. 4c is a schematic representation of a light emitting device comprising an LED,

FIG. 4d is a schematic representation of a light emitting device comprising a plurality of LEDs,

FIG. 5 illustrates a representation of the wavelength distribution of an example of three narrow bands of light,

FIG. 6a is a schematic representation of a light emitting device comprising an LED and a second polarisation filter,

FIG. 6b is a schematic representation of a light emitting device comprising an LED and a second polarisation filter,

FIG. 6c is a schematic representation of a light emitting device comprising an LED and a second polarisation filter,

FIG. 7 is a schematic representation of an underwater polarimetric reflectance imaging system comprising a light emitting device and a 2D array detector located inside a watertight housing,

FIG. 8 is a schematic representation of an underwater polarimetric reflectance imaging system comprising a light emitting device located inside a first watertight housing, and a 2D array detector located inside a second watertight housing,

FIG. 9 is a schematic representation of an underwater polarimetric reflectance imaging system comprising a 2D array detector and a colour filter located in front of the 2D array detector,

FIG. 10 is a schematic representation of an underwater polarimetric reflectance imaging system comprising a computer,

FIG. 11 is a schematic representation of a fish imaging method according to one embodiment of the present invention,

FIG. 12 is a schematic representation of a fish imaging method according to one embodiment of the present invention, and

FIG. 13 is a schematic representation of a method for detection of sea lice according to one embodiment of the present invention.

### DETAILED DESCRIPTION OF THE INVENTION

In the following, general embodiments as well as particular exemplary embodiments of the invention will be described. References will be made to the accompanying drawings. It shall be noted, however, that the drawings are exemplary embodiments only, and that other features and embodiments may well be within the scope of the invention as claimed.

The present invention is based on a discovery that one or more narrow bands of polarised light can be successfully employed in order to obtain images of sea lice contaminated fish with an enhanced contrast between the sea lice and the fish. The enhanced contrast has been found to originate from a difference in the birefringent properties of the exoskeleton of the sea lice compared to those of the skin of a fish, a difference that causes polarised light to disproportionally alter its polarisation when reflected of a louse compared to when reflected of the skin of a fish. Enhanced contrast between sea lice and fish has also been found to be obtainable via isotropic absorption.

The present invention relates to an underwater polarimetric reflectance imaging system, the use of such a system, a method for imaging sea lice contaminated fish, and a method for identifying lice in images obtained with the aforementioned method.

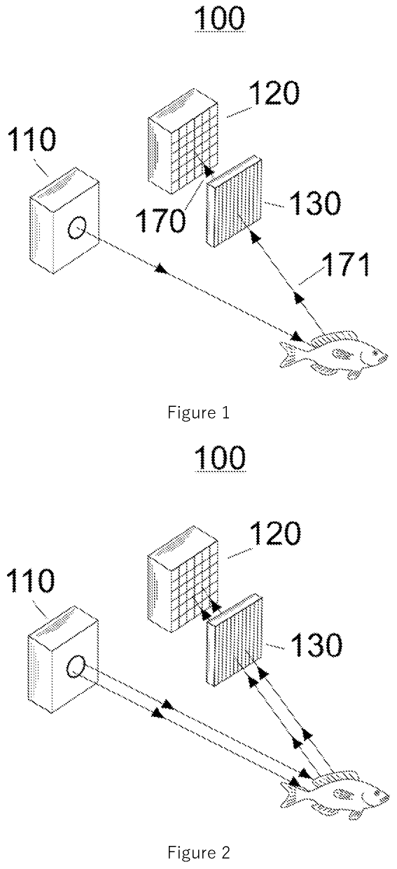

FIG. 1 illustrates an underwater polarimetric reflectance imaging system 100 comprising a light emitting device 110, a 2D array detector 120 and a first polarisation filter 130. The light emitting device 110 can here be seen to shine light onto a fish, where the light after being reflected of the fish and filtered by the polarisation filter 130 is detected by the array detector 120. The polarisation filter 130 is here positioned in front of the array detector 120.

The light emitting device 110 is according to the invention configured to emit a nonzero integer L number of narrow bands of light. These narrow bands may be emitted by the same light emitting device 110 or alternatively by different light emitting devices 110. The L number of narrow bands of light comprise(s) according to the invention a P number of polarised narrow bands of light, where P is a nonzero integer smaller or equal to L. FIG. 2 illustrates one embodiment of the invention where L>1 and P≥1.

The use of polarised narrow band light is motivated by the discovery that such light can be successfully employed in order to obtain images of sea lice contaminated fish with an enhanced contrast between the sea lice and the fish. The enhanced contrast is as mentioned caused by a disproportional alteration of the polarisation of narrow band light reflected of a louse compared to when reflected of the skin of a fish. Narrow band light is preferable to wide band light, as the polarisation of light with different wavelengths have been found to be altered in a different manner upon reflection of a sea louse.

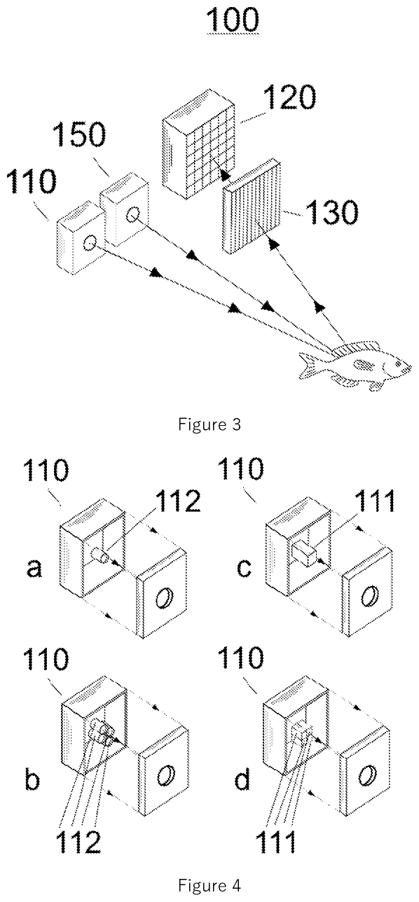

FIGS. 1 and 3 illustrates two alternative embodiments of the underwater polarimetric reflectance imaging system 100 where in FIG. 1 the light emitting device 110 comprises one single light emitting device 110 and where in FIG. 3 the light emitting device comprises two or more separate light emitting devices 110, 150. The invention is generally not limited to the use of one light emitting device 110, and the term light emitting device 110 may therefor in the context of the present invention be considered as one or more light emitting devices 110.

Any light emitting device 110 may as illustrated in FIG. 4 comprise one or more light sources, e.g. such as one or more LEDs 111, lasers 112, thermal light sources, plasma-based light sources, etc., or any combination of such. Different light emitting devices 110 may comprise different light sources, e.g. such that one light emitting device comprises a laser 112, while another light emitting device comprises an LED 111.

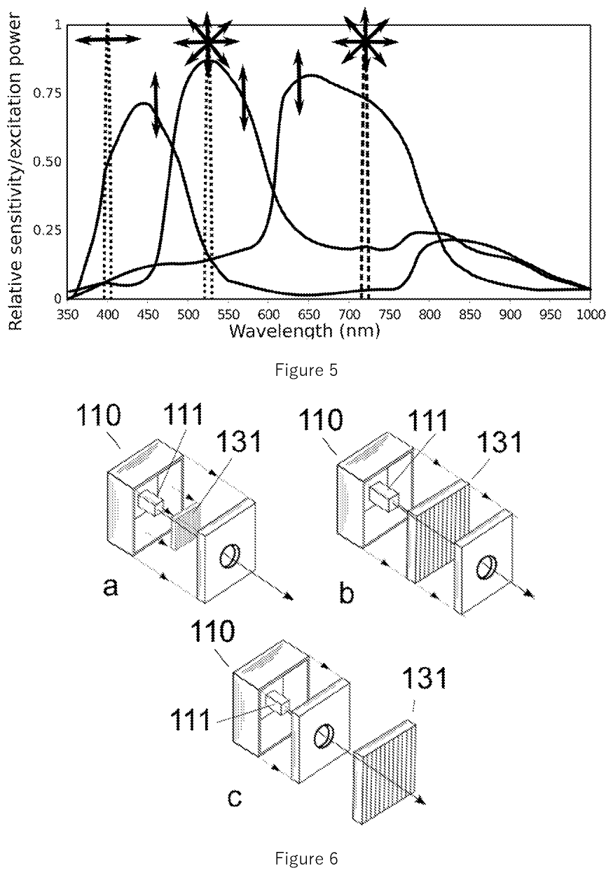

The light emitting device is as illustrated in FIG. 5 configured to emit a non-zero L number of narrow bands of light with an average wavelength in the range 350 nm-750 nm. A narrow band of light can generally be considered as light essentially within a limited wavelength interval. This interval can be as narrow as ˜1 nanometre or as high as several tens of nanometres. A narrow band can in other words be considered as a collection of light, where the majority of the light has a wavelength within a limited wavelength interval. The width of a narrow band of light can be quantitatively given using the expression full width half maximum (FWHM). A narrow band of light can thus be more accurately defined as a collection of light with an intensity distribution that has a FWHM less than a given value. A narrow band of light is according to the invention a band of light with a full width, half maximum (FWHM) of less than 70 nm. A narrow band of light may alternatively be considered as a band of light with a FWHM of less than 50 nm or as a band of light with a FWHM of less than 30 nm. A narrow band of light may according to the invention be a band of light that is essentially monochromatic, meaning for example that the narrow band of light is as monochromatic as that emitted by a laser.

The polarimetric reflectance imaging system is according to the invention configured to image sea lice contaminated fish that are swimming in water. The light emitting device is consequently configured to emit a narrow band of light with an average wavelength between 350 nm and 750 nm as light outside this wavelength interval has been found to be prone to absorption by the water. It has been discovered as a part of the present invention that light with different wavelengths, and optionally different polarisations, can be used to enhance different types of contrast in an image of a sea lice contaminated fish. A wavelength of approximately 405 nm is e.g. beneficial for generating a strong contrast between a fish and a louse, while light with a wavelength longer than 700 nm has been found to generate a strong contrast between lice at different development stages. The underwater polarimetric reflectance imaging system may therefore be configured to emit a narrow band of light with an average wavelength within 30 nm of 405 nm, or 730 nm. The underwater polarimetric reflectance imaging system may optionally be configured to emit both a polarised narrow band of light with an average wavelength within 30 nm of 405 nm and a polarised narrow band of light with an average wavelength within 30 nm of 730 nm. FIG. 5 shows one example of narrow bands of light with an average wavelength within 30 nm of 405 nm, 532 nm or 730 nm.

Polarised light is according to the invention defined as light that is linearly polarised, right hand polarised, left hand polarised, circularly polarised or elliptically polarised, etc. Polarised light differs from non-polarised light in that is has non-zero degree of polarisation (DOP), which is a quantity used to describe the portion of an electromagnetic wave which is polarised. The definition “polarised light” may according to the invention be considered as light with a DOP larger than 20%. Polarised light may in the context of the present invention alternatively be considered as light with a DOP larger than 40% or alternatively 60%.

The underwater polarimetric reflectance imaging system 100 comprises as illustrated in FIG. 1 a 2D array detector 120 comprising a plurality of pixel sensors. An array detector can be interpreted as a sensor array where the plurality of pixel sensors are arranged in a 2D geometrical pattern and configured to collect electromagnetic radiation, and optionally process a response triggered by electromagnetic radiation. Each pixel sensor may for example comprise a photo detector, and optionally an active amplifier.

The 2D array detector 120 may be a part of a camera comprising zero or more of elements like an objective lens, diaphragm, shutter mechanism, etc. The 2D array detector 120 is according to the invention arranged in order to detect light originating from the light emitting device 110. The 2D array detector 120 may, as illustrated in FIG. 1, for example be arranged in the same direction as the light emitting device 110, i.e. arranged facing the same direction as the light emitting device 110 is arranged to emit light. The 2D array detector 120 and the light emitting device 110 are generally arranged so that light emitted by the light emitting device 110 can be reflected of a surface, e.g. that of a fish or sea lice, and detected by the 2D array detector 120.

The underwater polarimetric reflectance imaging system 100 comprises as illustrated in FIG. 1 a first polarisation filter 130. This polarisation filter 130 is shown in FIG. 1 as positioned in an optical pathway between the light emitting device 110 and the 2D array detector 120. The first polarisation filter 130 can generally be considered as positioned in front of the 2D array detector 120, but this may in the context of the invention be interpreted as positioned in an optical pathway between the light emitting device 110 and the 2D array detector 120. The first polarisation filter 130 is, when the underwater polarimetric reflectance imaging system 100 is used for detection of sea lice on a fish, positioned between the fish and the 2D array detector 120. The first polarisation filter 130 may alternatively be positioned right in front of the 2D array detector 120, optionally as a part of a larger camera structure comprising the 2D array detector 120.

The first polarisation filter is according to the invention an optical filter configured to allow light with a certain polarisation to pass while blocking light with other polarisations. The first polariser may comprise a linear polariser, circular polariser, or other types of polariser, and may e.g. be an absorptive polariser or a beam splitting polariser. As no polarisation filter is 100% ideal, a polarisation filter may in the context of the invention be considered as a polarisation filter that allows light waves with an approximate polarisation to pass while blocking light waves with other polarisations. A polariser may typically considered as having a design wavelength region where its polarisation properties are near optimal, e.g. 99.99%. When used on the edge of this region, or in other regions the performance may e.g. drop down to 70-90%.

FIG. 1 is a schematic illustration of an underwater polarimetric reflectance imaging system 100 where the light emitting device 110, the 2D array detector 120 and the first polarisation filter 130 are all arranged in the same plane. The light emitting device 110 may here emit a linearly polarised narrow band of light, e.g. towards a fish contaminated by a louse, with a polarisation direction that lies in the plane. The light will, upon being reflected of the louse, alter its polarisation, resulting in a reflection with an altered polarisation different from the light emitted by the light emitting device 110. The light reflected of the skin of the fish will on the contrary not have a significantly altered polarisation, and will thus maintain is original polarisation in the plane after being reflected. The first polarisation filter 130 is in this embodiment of the invention a linear polariser, i.e. configured to block light with a linear polarisation in a given direction. The first polarisation filter 130 may here be arranged either such that it blocks light with a polarisation direction essentially in the plane, or such that it blocks light with a polarisation direction essentially perpendicular to the plane. The meaning of the terms “essentially in the plane” and “essentially perpendicular to the plane” will here be understood by a person skilled in the art to be dependent on the polarization filter used. A polarisation direction “essentially in the plane” and “essentially perpendicular to the plane” may e.g. be interpreted respectively as a polarisation direction within ≲20° of the plane or the plane normal respectively. A polarisation direction “essentially in the plane” and “essentially perpendicular to the plane” may alternatively be interpreted respectively as a polarisation direction within ≲10° of the plane or the plane normal respectively. The light will, upon being reflected of the fish, and of the louse, alter the polarisation state, resulting in a different polarisation state than of the light emitted by the light emitting device. The polarisation state reflected from the skin of the fish will be significantly different compared to that being reflected of the louse. The resulting filtered reflected polarised narrow band of light now contains a high contrast between the louse and the fish, and can consequently be detected by the 2D array detector in order to obtain a high contrast image of the louse and the fish.

The light emitting device 110 is according to the invention configured to emit a P number of polarised narrow bands of light where the number P is lower or equal to L. The polarisation of the P number of narrow bands of light may originate from intrinsic properties of the light emitting device 110, or may alternatively be obtained through employment of one or more polarisation filters. FIGS. 4 a and 4 b illustrate an embodiment of the invention where the light emitting device comprises a laser 112, which due to intrinsic properties emits polarised light directly. The laser 112 may in this embodiment of the invention be replaced by any other intrinsically polarised light source. A light emitting device 110 may as illustrated in FIG. 4 b comprise a plurality of lasers 112.

FIG. 6 illustrate another embodiment of the invention, where the light emitting device 110 comprises a non-polarized light source (in this example an LED 111) and a second polarisation filter 131 arranged in front of the non-polarized light source. In FIG. 6, the light from the LED 111 is filtered by the second polarisation filter in order to obtain polarised light. The LED 111 may in this embodiment be a coloured LED 111, like a blue, green or red LED 111 etc. The second polarisation filter 131 in this embodiment of the invention be considered as a part of the light emitting device 110 regardless of its position in the underwater polarimetric reflectance imaging system 100. The second polarisation filter 131 may be positioned in front of the LED 111 adjacent to the LED 111, or alternatively in a remote position from the LED 111. The second polarisation filter 131 can, when the underwater polarimetric reflectance imaging system 100 is used for detection of sea lice on a fish, generally be considered to be positioned between the LED 111 and the fish. The LED 111 may in this embodiment of the invention be replaced by any non-intrinsically polarised light source, such as for example incandescent lamps. A light emitting device may as illustrated in FIG. 6 d comprise a plurality of LEDs 111.

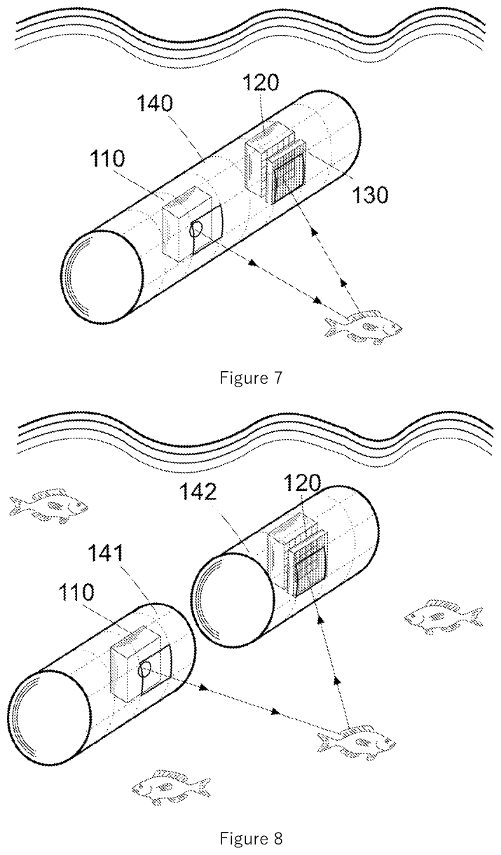

FIG. 7 illustrates an embodiment of the invention where the light emitting device 110 and the 2D array detector 120 are placed under water. The constituents of the underwater polarimetric reflectance imaging system are according to the invention generally configured to be placed under water, either by making one or more of the constituents intrinsically watertight or by placing them in one or more watertight housings 140. The light emitting device 110 and the 2D array detector 120 are in FIG. 7 arranged in a watertight housing 140, but may alternatively be arranged separate watertight housings 140. Some constituents of the underwater polarimetric reflectance imaging system may alternatively be intrinsically watertight, while others may be positioned a watertight housing 140. A watertight housing 140 is according to the invention configured to allow electromagnetic communication, e.g. allow visible transmission, between the interior and exterior of the housing 140, e.g. via a window in the housing 140. FIG. 7 is a schematic illustration where the light emitting device 110, the 2D array detector 120 and the first polarisation filter 130 are arranged in the same watertight housing 140. FIG. 8 illustrates one embodiment of the invention where the light emitting device 110 is arranged in a first watertight housing 141, while the 2D array detector 120 and the first polarisation filter 130 are arranged in a second watertight housing 142 separate from the first watertight housing 141.

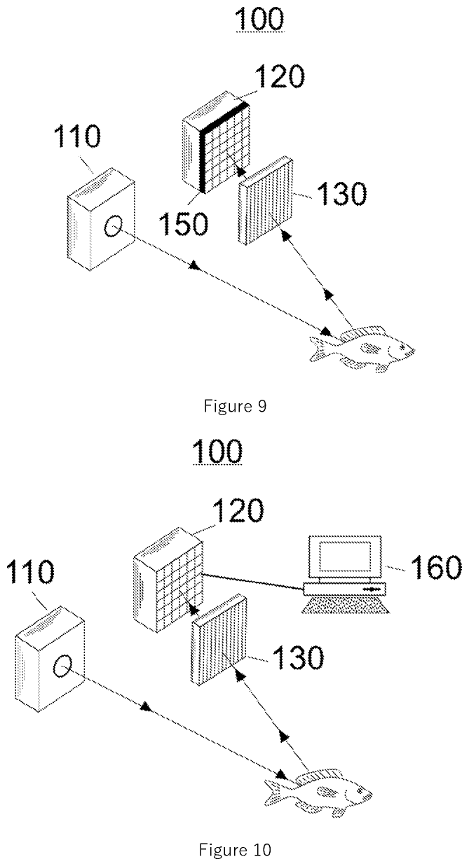

FIG. 9 illustrates an embodiment of the invention where the underwater polarimetric reflectance imaging system 100 comprises a colour filter 150 arranged in front of the 2D array detector 120. The colour filter 150 is here a colour filter array comprising a mosaic of small colour filters, each positioned such that it covers at least one pixel sensor of the 2D array detector. The colours filter array may according to this embodiment be a Bayer filter, but could alternatively be an RGBE filter, a CYYM filter, an RGBW filter, or similar. The colour filter 150 may e.g. be used in order to filter out colours of interest when detecting light with the 2D array detector.

FIG. 10 illustrates an underwater polarimetric reflectance imaging system 100 comprising a computer 160 connected to the 2D array detector 120. The computer 160 is in this embodiment employed in order to analyse signals from the 2D array detector 120 in order to determine whether there is a sea louse on a fish. The computer 160 may be a separate computer, or may alternatively be built-in with the 2D array detector 120. A computer may here be interpreted generally as a device at least configured to process signals from the 2D array detector 120 in order to generate a digital image.

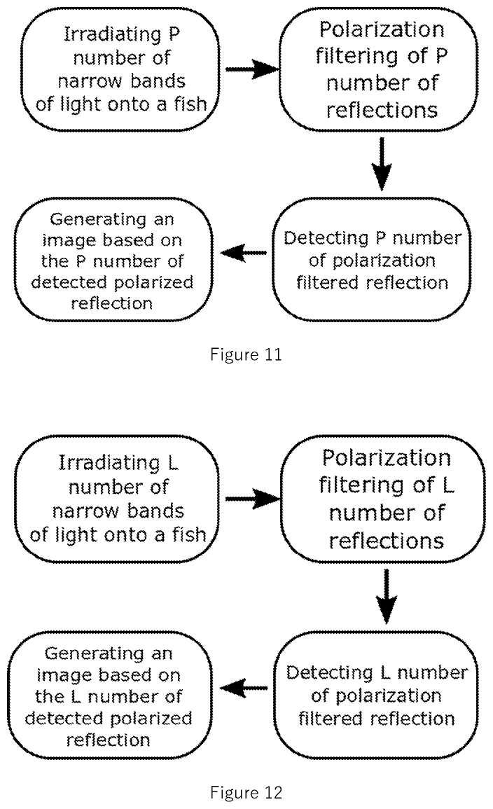

Another aspect of the invention relates to a fish imaging method for obtaining an image with a high contrast between fish and sea lice. The method comprises, as illustrated in FIGS. 11 and 12, the steps of irradiating an L number of narrow bands of light onto a fish, performing polarisation filtering of a reflection of each of the L number of narrow bands of light irradiated onto the fish, detecting the polarisation filtered reflection of each of the L number of narrow bands of light irradiated onto the fish, and generating an image of the fish from the detected filtered reflection(s) of the nonzero P number of polarised narrow bands of light irradiated onto the fish. The L number of narrow bands of light irradiated onto the fish, each has a FWHM<70 nm and an average wavelength in the range 350 nm-750 nm. The method may generally be executed using the previously described underwater polarimetric reflectance imaging system according to any embodiment of the invention.

A nonzero P number of the L number of narrow bands of light irradiated onto the fish is/are according to the invention polarised. L and P may in principle be any nonzero integer, as long as P is smaller or equal to L. L is according to one embodiment of the invention equal to P equal to 1. L and P may for example be simultaneously be equal to 2 or 3, or L may alternatively be equal to 2 or 3, while P equals to L−1.

Any combination of narrow bands of light, both polarised and non-polarised, may in general be used in order to obtain an image of a sea lice contaminated fish. Multiple narrow bands of light, both polarised and non-polarised, may in general be used to generate the same or separate images. Polarised light may as stated previously be used in order to obtain a high contrast between fish and sea louse, while non-polarised light e.g. may be used to generate contrast within the fish, or be used as an intensity normalizer etc. An image may according to one embodiment of the invention be generated from both the detected filtered reflection(s) of a nonzero P number of polarised narrow bands of light irradiated onto a fish, and from detected filtered reflection(s) of an L−P number of non-polarised narrow bands of light irradiated onto the fish.

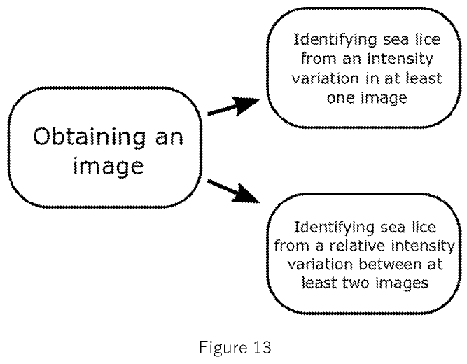

When one or more images of a sea lice contaminated fish has been obtained through the above method, these may further be analysed in order to identify a number of sea lice on the fish, optionally also the stage of each lice. A flow diagram illustrating a method for detection of sea lice on fish is shown in FIG. 13. The procedure of identifying a number of sea lice on the fish can generally be performed though standard image recognition procedures, i.e. where the one or more images of the sea lice contaminated fish e.g. is/are compared with existing images of sea lice contaminated fish and or images of sea lice. The procedure of identifying a number of sea lice on the fish involves according to one embodiment of the invention an evaluation of the variation in the intensity in at least one image obtained using the fish imaging method according to this invention. The procedure of identifying a number of sea lice on the fish alternatively involves an evaluation of the variation in the relative intensity between at least two images obtained using the fish imaging method according to this invention.

| Term: | Figure reference |
|---|---|
| Underwater polarimetric reflectance | 100 |
| imaging system | |
| Light emitting device | 110 |
| LED | 111 |
| Laser | 112 |
| Second light emitting device | 115 |
| 2D array detector | 120 |
| First polarisation filter | 130 |
| Second polarisation filter | 131 |
| Watertight housing | 140 |
| First watertight housing | 141 |
| Second watertight housing | 142 |
| Colour filter array | 150 |
| Computer | 160 |
| Polarisation filtered reflection | 170 |
| Reflection of a narrow band of light | 171 |
| Term: | Abbreviation |
| Full width half maximum | FWHM |
| Light emitting diode | LED |
| Degree of polarisation | DOP |

1-15. (canceled)

16. An underwater polarimetric reflectance imaging system for imaging sea lice contaminated fish, the system comprising:
a light emitting device configured to emit an L number of narrow bands of light, where each narrow band of light has a FWHM<70 nm and an average wavelength in the range 350 nm-750 nm, and where a nonzero P number of the L number of narrow bands of light is/are polarized;
a 2D array detector comprising a plurality of pixel sensors, where the 2D array detector is arranged in order to detect light originating from the light emitting device; and
a first polarisation filter positioned in front of the 2D array detector.

17. The underwater polarimetric reflectance imaging system according to claim 16, where L>1 and P≥1.

18. The underwater polarimetric reflectance imaging system according to claim 16, where at least one of the nonzero P number of polarised narrow bands of light has an average wavelength within 30 nm of 405 nm or 730 nm.

19. The underwater polarimetric reflectance imaging system according to claim 16, where the light emitting device, the 2D array detector and the first polarisation filter are arranged in the same plane, where at least one of the nonzero P number of polarised narrow bands of light emitted by the light emitting device is linearly polarised with a polarisation direction lying in the plane, and where the first polarisation filter is a linear polariser arranged such that it blocks light with
a) a polarisation direction essentially in the plane, or
b) a polarisation direction essentially perpendicular to the plane.

20. The underwater polarimetric reflectance imaging system according to claim 16, where the light emitting device comprises:
an LED and a second polarisation filter arranged in front of the LED; and/or
a laser.

21. The underwater polarimetric reflectance imaging system according to claim 16, where
the light emitting device, the 2D array detector and the first polarisation filter are arranged in the same watertight housing, or where
the light emitting device is arranged in a first watertight housing, and the 2D array detector and the first polarisation filter are arranged in a second watertight housing separate from the first watertight housing.

22. The underwater polarimetric reflectance imaging system according to claim 16, where the light emitting device is configured to emit a narrow band of light with a FWHM<30 nm.

23. The underwater polarimetric reflectance imaging system according to claim 16, further comprising a colour filter array arranged in front of the 2D array detector so that each pixel of the colour filter array covers a pixel sensor of the 2D array detector.

24. The underwater polarimetric reflectance imaging system according to claim 16, further comprising a second light emitting device configured to emit an L number of narrow bands of light, where each narrow band of light has a FWHM<70 nm and an average wavelength in the range 350 nm-750 nm, and where a nonzero P number of the L number of narrow bands of light is/are polarised.

25. The underwater polarimetric reflectance imaging system according to claim 16, further comprising a computer connected with the 2D array detector, where the computer is configured to generate an image based on a signal detected by the 2D array detector.

26. Use of the system according to claim 16 for imaging sea lice contaminated fish.

27. A fish imaging method for obtaining an image with a high contrast between fish and sea lice, the method comprising the steps of:
irradiating an L number of narrow bands of light onto a fish, where each narrow band of light has a FWHM<70 nm and an average wavelength in the range 350 nm-750 nm, and where a nonzero P number of the L number of narrow bands of light is/are polarized;
performing polarisation filtering of a reflection of each of the L number of narrow bands of light irradiated onto the fish;
detecting the polarisation filtered reflection of each of the L number of narrow bands of light irradiated onto the fish; and
generating an image of the fish from the detected filtered reflection(s) of the nonzero P number of polarised narrow bands of light irradiated onto the fish.

28. The method according to claim 27, where L=P=1.

29. The method according to claim 27, where the image is generated from the detected filtered reflection(s) of the nonzero P number of polarised narrow bands of light irradiated onto the fish, and from the detected filtered reflection(s) of the L−P number of non-polarised narrow bands of light irradiated onto the fish.

30. A method for detecting sea lice on fish, the method comprising the steps of:
obtaining one or more images of a fish by employing the method according to claim 12; and
identifying a sea lice in the image by
a) evaluating the variation in the intensity in at least one image, or by
b) evaluating the variation in the relative intensity between at least two images.
